(19) United States
(12) Patent Application Publication
(10) Pub. No.: US 2022/0223152 A1
(43) Pub. Date: Jul. 14, 2022

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: KENJI OGAWA, TOKYO (JP); AKIHIKO IZUMI, TOKYO (JP); TAICHI SHIMOYASHIKI, TOKYO (JP); TOMOYA FUJITA, TOKYO (JP); KENJI HISANAGA, TOKYO (JP)

(21) Appl. No.: 17/613,357

(22) PCT Filed: Apr. 24, 2020
(86) PCT No.: PCT/JP2020/017814

§ 371 Date: Nov. 22, 2021

(30) Foreign Application Priority Data
May 30, 2019 (JP) 2019-100956

(51) Int. Cl. G10L 15/22; G10L 15/30; G10L 15/183

(52) U.S. Cl. CPC G10L 15/22; G10L 2015/223; G10L 15/183; G10L 15/30

(57) ABSTRACT

An information processing device according to an embodiment of the present disclosure includes an external device controller, an external-device-state recognizer, and a model obtaining section. The external device controller transmits a plurality of commands to one or a plurality of external devices to be controlled. The external-device-state recognizer recognizes states of the one or plurality of external devices of before and after transmission of the plurality of commands performed by the external device controller. The model obtaining section generates a state transition model in which the plurality of commands transmitted from the external device controller is associated with the states of the one or plurality of external devices of before and after the transmission of the plurality of commands performed by the external device controller.

### TECHNICAL FIELD

The present disclosure relates to an information processing device configured to perform voice recognition, and to an information processing method and an information processing program executable by the information processing device configured to perform voice recognition.

### BACKGROUND ART

In recent years, a technique of operating a surrounding device by voice recognition has been developed (e.g., see PTLs 1 and 2).

### CITATION LIST

### Patent Literature

PTL 1: Japanese Unexamined Patent Application Publication No. 2003-111157

PTL 2: Japanese Unexamined Patent Application Publication No. 2005-86768

### SUMMARY OF THE INVENTION

Incidentally, it is very troublesome for a user to successively input a large number of voice commands in order to bring a surrounding device into a target state (goal state). It is desirable to provide an information processing device, an information processing method, and an information processing program that make it possible to operate the surrounding device to be brought into the goal state by inputting one voice command.

An information processing device according to an embodiment of the present disclosure includes an external device controller, an external-device-state recognizer, and a model obtaining section. The external device controller transmits a plurality of commands to one or a plurality of external devices to be controlled. The external-device-state recognizer recognizes states of the one or plurality of external devices of before and after transmission of the plurality of commands performed by the external device controller. The model obtaining section generates a state transition model in which the plurality of commands transmitted from the external device controller is associated with the states of the one or plurality of external devices of before and after the transmission of the plurality of commands performed by the external device controller.

An information processing method according to an embodiment of the present disclosure includes the following two steps:

(A) transmitting a plurality of commands to one or a plurality of external devices to be controlled, and recognizing states of the one or plurality of external devices of before and after transmission of the plurality of commands by receiving responses of the plurality of commands; and
(B) generating a state transition model in which the transmitted plurality of commands is associated with the states of the one or plurality of external devices of before and after the transmission of the plurality of commands.

An information processing program according to an embodiment of the present disclosure causes a computer to execute the following two steps:

(A) by outputting a plurality of commands to an external device controller, causing the plurality of commands to be outputted, from the external device controller, to one or a plurality of external devices to be controlled, and thereafter obtaining states of the one or plurality of external devices of before and after transmission of the plurality of commands by receiving responses of the plurality of commands, and
(B) generating a state transition model in which the outputted plurality of commands is associated with the states of the one or plurality of external devices of before and after the transmission of the plurality of commands.

In the information processing device, the information processing method, and the information processing program according to an embodiment of the present disclosure, the state transition model is generated in which the plurality of commands transmitted to the one or plurality of external devices to be controlled is associated with the states of the one or plurality of external devices of before and after the transmission of the plurality of commands Thus, it is possible to control the one or plurality of external devices to be controlled toward a goal state corresponding to a command inputted from the outside, while selecting the command to be executed from the state transition model.

### BRIEF DESCRIPTION OF DRAWINGS

FIG. 1 is a diagram illustrating an example of a schematic configuration of an agent device according to an embodiment of the present disclosure.

FIG. 2 is a diagram illustrating an example of a model to be stored in a device-control-model database illustrated in FIG. 1.

FIG. 3 is a diagram illustrating an example of a model to be stored in a device-control-model-sharing database illustrated in FIG. 1.

FIG. 4 is a diagram illustrating an example of a procedure of creating a state transition model.

FIG. 5 is a diagram illustrating an example of a procedure of registering a voice command.

FIG. 6 is a diagram illustrating an example of a procedure of executing the voice command.

FIG. 7 is a diagram illustrating an example of a procedure of correcting the voice command.

FIG. 8 is a diagram illustrating a modification example of the schematic configuration of the agent device illustrated in FIG. 1.

FIG. 9 is a diagram illustrating an example of a schematic configuration of a mobile terminal illustrated in FIG. 8.

FIG. 10 is a diagram illustrating a modification example of the schematic configuration of the agent device illustrated in FIG. 1.

FIG. 11 is a diagram illustrating a modification example of a schematic configuration of the agent device illustrated in FIG. 8.

### MODES FOR CARRYING OUT THE INVENTION

In the following, some embodiments of the present disclosure are described in detail with reference to the drawings. It is to be noted that, in this description and the accompanying drawings, components that have substantially the same functional configuration are denoted by the same reference signs, and thus redundant description thereof is omitted. Description is given in the following order.

### 1. Background

### 2. Embodiment

An example of executing a process on a voice command on a goal base

### 3. Modification Examples

An example of displaying UI on a screen of a mobile terminal

An example in which a portion of a goal-based execution section includes a program

### 1. BACKGROUND

One approach to controlling an AI (artificial intelligence) character in a game is a goal base. The goal base means that, instead of input of an action string as a command to control the AI character, input of a goal state allows the AI character to select and execute various actions on its own toward an indicated goal state to achieve the goal state. In a case where an existing action sequence is inputted as a command, it is necessary to determine a series of action sequences for moving into a goal state after grasping a present state in advance, and to input the action sequences. However, in the goal base, it is only necessary to indicate the goal state, and even in a case where a surrounding state changes in the middle and an action to be performed changes, it becomes possible to provide an autonomy that the AI character switches actions adaptively by itself and advances toward the goal state.

Hereinafter, using this concept for controlling external devices in a real world, the “goal base” will be used as a term indicating a method of, when a user gives an instruction of the goal state, automatically performing control on each of the plurality of external devices to be turned from a present state into the goal state while executing a plurality of commands on the external devices.

PTL 1 (Japanese Unexamined Patent Application Publication No. 2003-111157) discloses an integrated controller that is able to comfortably control various devices in accordance with a user's lifestyle habit, lifestyle environments, and the like, or in accordance with a user's preference. PTL 2 (Japanese Unexamined Patent Application Publication No. 2005-86768) discloses a control device that is able to easily operate various devices with a setting matching each user's habit, by using a network to which the various devices are coupled.

In PTLs 1 and 2, it is based on the premise that the user's habit is obtained, and it is not possible to obtain/execute an action that the user has not performed. Hereinafter, an agent device will be described on the basis of a goal-based concept, which is able to control each of devices toward the goal state while adaptively changing commands to be sent to the devices.

### 2. EMBODIMENT

### [Configuration]

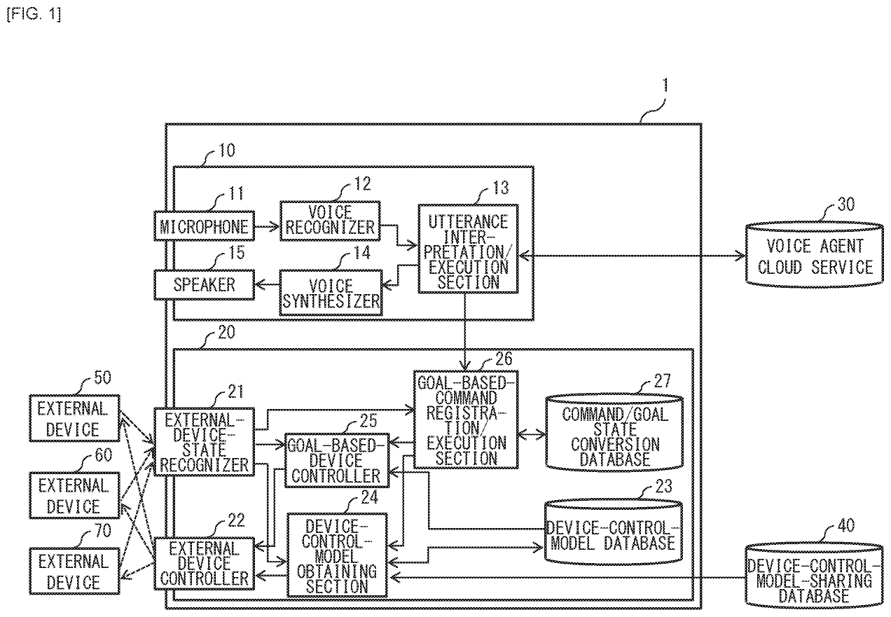

An agent device 1 according to an embodiment of the disclosure will be described. FIG. 1 illustrates an example of a schematic configuration of the agent device 1. The agent device 1 includes a command acquisition section 10 and a goal-based execution section 20.

The agent device 1 is coupled to a voice agent cloud service 30 and a device-control-model-sharing database 40 via a network. The device-control-model-sharing database 40 corresponds to a specific example of a “storage” of the present disclosure. One or a plurality of external devices (e.g., external devices 50, 60, and 70) to be controlled are installed around the agent device 1. The external device 50 is, for example, a television. The device-control-model-sharing database 40 is, for example, a data base that operates as a cloud service. The device-control-model-sharing database 40 may include, for example, a volatile memory such as a DRAM (Dynamic Random Access Memory) or a non-volatile memory such as an EEPROM (Electrically Erasable Programmable Read-Only Memory) or a flash memory. The external device 60 is, for example, a lighting apparatus of a room. The external device 70 is, for example, a player such as a DVD (registered trademark) or a BD (registered trademark). It is to be noted that the external devices 50, 60, and 70 are not limited to the above-described devices.

Here, the network is, for example, a network that performs communication using a communication protocol (TCP/IP) that is normally used on the Internet. The network may be, for example, a secure network that performs communication using a communication protocol of its own network. The network may be, for example, the Internet, an intranet, or a local area network. The network and the agent device 1 may be coupled to each other via, for example, a wired LAN (Local Area Network) such as Ethernet (registered trademark), a wireless LAN such as a Wi-Fi, a cellular telephone line, or the like.

### (Command Acquisition Section 10)

The command acquisition section 10 acquires a voice command by voice recognition. The command acquisition section 10 includes, for example a microphone 11, a voice recognizer 12, an utterance interpretation/execution section 13, a voice synthesizer 14, and a speaker 15.

The microphone 11 receives ambient sound and outputs a sound signal obtained therefrom to the voice recognizer 12. The voice recognizer 12 extracts an utterance voice signal of a user, which is included in the inputted sound signal, and outputs the utterance voice signal to the utterance interpretation/execution section 13. The utterance interpretation/execution section 13 outputs the inputted utterance voice signal to the voice agent cloud service 30. The utterance interpretation/execution section 13 extracts a command (voice command) included in text data obtained from the voice agent cloud service 30 and outputs the command to the goal-based execution section 20. The utterance interpretation/execution section 13 generates voice text data using the text data and outputs the voice text data to the voice synthesizer 14. The voice synthesizer 14 generates a sound signal on the basis of the inputted voice text data, and outputs the sound signal to the speaker 15. The speaker 15 converts the inputted sound signal into a voice, and outputs the voice to the outside.

The voice agent cloud service 30 receives utterance voice data of the user from the agent device 1 (utterance interpretation/execution section 13). The voice agent cloud service 30 converts the received utterance voice data into text by voice recognition, and outputs the text data obtained by the text conversion to the agent device 1 (utterance interpretation/execution section 13).

### (Goal-Based Execution Section 20)

The goal-based execution section 20 controls, on the basis of a goal-based concept, one or a plurality of external devices to be controlled (e.g., external devices 50, 60, and 70) toward the goal state while adaptively changing commands to be sent to the external devices. The goal-based execution section 20 includes, for example, an external-device-state recognizer 21, an external device controller 22, a device-control-model database 23, a device-control-model obtaining section 24, a goal-based-device controller 25, a goal-based-command registration/execution section 26, and a command/goal state conversion database 27. The device-control-model database 23 corresponds to a specific example of the “storage” of the present disclosure. The goal-based-command registration/execution section 26 corresponds to a specific example of an “execution section” of the present disclosure.

The external-device-state recognizer 21 recognizes a type and a present state of the one or plurality of external devices to be controlled. The external-device-state recognizer 21 recognizes, for example, states of the one or plurality of external devices of before and after transmission of a plurality of commands performed by the external device controller 22.

In the external-device-state recognizer 21, a recognition method differs depending on the type of the one or plurality of external devices to be controlled. For example, in a case where the external device is coupled to a network, the external-device-state recognizer 21 may be configured to be able to recognize the state of the external device by communicating with the external device coupled to the network. In this case, the external-device-state recognizer 21 includes, for example, a communication device configured to communicate with the one or plurality of external devices coupled to the network. Further, for example, in a case where a state of the external device is recognizable from an appearance, the external-device-state recognizer 21 may be configured to be able to recognize the state of the external device by imaging the external device. In this case, the external-device-state recognizer 21 includes, for example, an imaging device configured to image the one or plurality of external devices. Further, for example, in a case where the state of the external device is recognizable from a sound outputted from the relevant external device, the external-device-state recognizer 21 may be configured to be able to recognize the state of the external device by acquiring the sound outputted from the external device. In this case, the external-device-state recognizer 21 includes, for example, a sound collecting device configured to acquire the sound outputted by the one or plurality of external devices. Further, for example, in a case where the external device is configured to be controllable by an infrared remote control code, the external-device-state recognizer 21 may be configured to be able to recognize the state of the external device by receiving the infrared remote control code transmitted to the external device. In this case, the external-device-state recognizer 21 includes, for example, a reception device configured to receive the infrared remote control code transmitted to the one or plurality of external devices. It is to be noted that, in this case, the infrared remote control code is an example of a code to be received by the external-device-state recognizer 21, and the code to be received by the external-device-state recognizer 21 is not limited to the infrared remote control code. Further, for example, in a case where the external device is configured to be controllable by a code different from the infrared remote control code, the external-device-state recognizer 21 may be configured to be able to recognize the state of the external device by receiving the code transmitted to the external device. In this case, the external-device-state recognizer 21 includes, for example, a reception device that is able to receive the code transmitted to the one or plurality of external devices. The external-device-state recognizer 21 may include, for example, at least one of the communication device, the imaging device, the sound collecting device, or the reception device.

The external device controller 22 executes control for changing the state of the one or plurality of external devices to be controlled. The external device controller 22 controls the external device by, for example, transmitting a plurality of commands to the one or plurality of external devices to be controlled. In the external device controller 22, a control method differs depending on the type of the one or plurality of external devices to be controlled.

For example, in the case where the external device is coupled to a network, the external device controller 22 may be configured to be able to control the external device by communicating with the external device coupled to the network. Further, for example, in the case where the external device is configured to be controllable by the infrared remote control code, the external device controller 22 may be configured to be able to control the external device by transmitting the infrared remote control code to the external device. Further, for example, in a case where the external device includes a physical input interface, such as a button or a switch, the external device controller 22 may be configured to be able to operate the external device via a robotic manipulator.

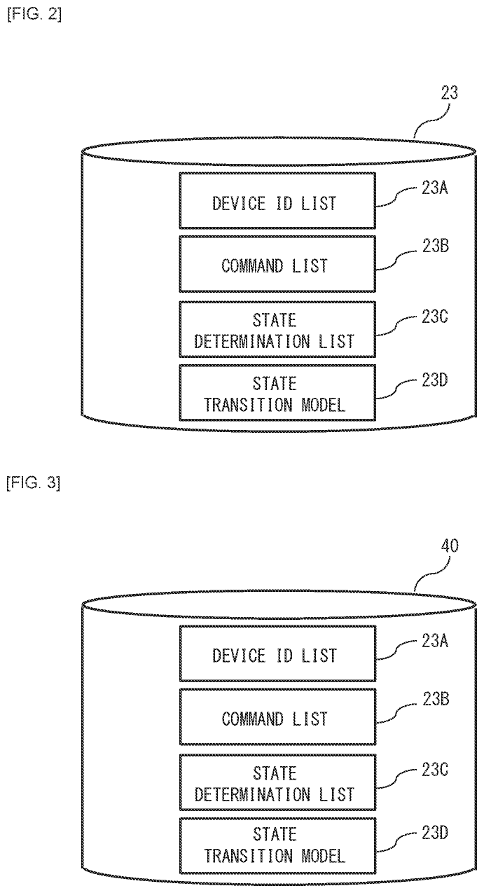

The device-control-model database 23 stores a device control model M. The device-control-model-sharing database 40 stores the device control model M. The device control model M stored in the device-control-model database 23 and in the device-control-model-sharing database 40 includes, as illustrated in FIGS. 2 and 3, a device ID list 23A, a command list 23B, a state determination list 23C, and a state transition model 23D. The device control model M may be stored in a volatile memory such as a DRAM (Dynamic Random Access Memory) or in a non-volatile memory such as an EEPROM (Electrically Erasable Programmable Read-Only Memory) or a flash memory.

The device ID list 23A includes an identifier (external device ID) assigned to each external device. The external device ID is generated by the device-control-model obtaining section 24 on the basis of, for example, information obtained from the external device. The external device ID includes, for example, a manufacturer and a model number of the external device. The external device ID may be generated by the device-control-model obtaining section 24 on the basis of, for example, information obtained from an image of an external appearance image of the external device. The external device ID may be generated by the device-control-model obtaining section 24 on the basis of, for example, information inputted by the user.

The command list 23B includes a table (hereinafter referred to as “table A”) in which the external device ID is associated with a plurality of commands that is acceptable in the external device corresponding to the external device ID. The table A corresponds to a specific example of a “first table” according to the present disclosure. The command list 23B includes the table A for each external device ID. The command list 23B is generated by the device-control-model obtaining section 24 on the basis of, for example, the information (external device ID) obtained from the external device and information (a command list) pre-installed for the device-control-model database 23 or the device-control-model-sharing database 40. The command list 23B may be generated by the device-control-model obtaining section 24 on the basis of, for example, the information (external device ID) obtained from the external device and the infrared remote control code transmitted to the external device. The command list 23B may be, for example, pre-installed for the device-control-model database 23 or the device-control-model-sharing database 40.

The state determination list 23C includes a table (hereinafter referred to as “table B”) in which the external device ID is associated with information regarding a method configured to determine a state of the external device corresponding to the external device ID. The table B corresponds to a specific example of a “second table” according to the present disclosure. The state determination list 23C includes the table B for each external device ID. The state determination list 23C is generated by the device-control-model obtaining section 24 on the basis of, for example, the information (external device ID) obtained from the external device and the information (state determination method) pre-installed for the device-control-model database 23 or the device-control-model-sharing database 40. The state determination list 23C may be, for example, pre-installed for the device-control-model database 23 or the device-control-model-sharing database 40.

The state transition model 23D includes, for example, a table (hereinafter referred to as “table C”) in which the external device ID, the plurality of commands that is acceptable in the external device corresponding to the external device ID, and states of the external device corresponding to the external device ID of before and after transmission of the plurality of commands performed by the external device controller 22, are associated with each other. The state transition model 23D includes, for example, the table C for each external device ID. The state transition model 23D is generated by the device-control-model obtaining section 24 on the basis of, for example, the information obtained from the external device.

The state transition model 23D may be a learning model generated by machine learning. In this case, the state transition model 23D is configured to, when a state (present state) of the one or plurality of external devices to be controlled and a goal state are inputted, output one or a plurality of commands (i.e., one or a plurality of commands to be executed next) that is necessary for turning into the inputted goal state.

The device-control-model obtaining section 24 generates the external device ID on the basis of, for example, information obtained from the external-device-state recognizer 21. The device-control-model obtaining section 24 may generate the external device ID on the basis of, for example, information inputted by the user. The device-control-model obtaining section 24 may, for example, store the generated external device ID in the device-control-model database 23 and the device-control-model-sharing database 40.

The device-control-model obtaining section 24 generates the command list 23B on the basis of, for example, the information (external device ID) obtained from the external device and a command inputted from the device-control-model obtaining section 24 to the external device controller 22. The device-control-model obtaining section 24 may store the external device ID and the command in association with each other in the command list 23B only in a case where, for example, there is a change in the states of the external device corresponding to the external device ID of before and after the transmission of the command performed by the external device controller 22. That is, the device-control-model obtaining section 24 may store the external device ID and the command in association with each other in the command list 23B only in a case where, for example, the external device executes the command. The device-control-model obtaining section 24 may, for example, store the generated command list 23B in the device-control-model database 23 and the device-control-model-sharing database 40.

The device-control-model obtaining section 24 generates the state determination list 23C on the basis of, for example, the information (external device ID) obtained from the external device and the information (state determination method) obtained from the device-control-model database 23 or the device-control-model-sharing database 40. The device-control-model obtaining section 24 may, for example, store the generated state determination list 23C in the device-control-model database 23 and the device-control-model-sharing database 40.

The device-control-model obtaining section 24 generates the state transition model 23D on the basis of, for example, the information (external device ID) obtained from the state transition model 23D, the command inputted from the device-control-model obtaining section 24 to the external device controller 22 (the command transmitted from the external device controller 22), and the information (states of the external device corresponding to the external device ID of before and after the transmission of the command performed by the external device controller 22) obtained from the external device. The device-control-model obtaining section 24, for example, uses machine learning (e.g., reinforcement learning) to generate the state transition model 23D on the basis of the state of the external device obtained by the external-device-state recognizer 21 while transmitting various commands to the external device controller 22. The device-control-model obtaining section 24 may, for example, store the generated state transition model 23D in the device-control-model database 23 and the device-control-model-sharing database 40.

The device-control-model obtaining section 24 may create, for example, a portion of the state transition model 23D by using programming or the like, without using machine learning, (e.g., reinforcement learning). This method is useful in a case where machine control is too complicated to obtain the portion of the state transition model 23D by machine learning, in a case where the determination of the state of the external device is insufficient by observation from the outside, in a case where the portion of the state transition model 23D is sufficiently simple and it is possible to make obtaining of the portion of the state transition model 23D compact and efficient by not using machine learning, or the like.

The goal-based-device controller 25 controls the one or plurality of external devices to be controlled, using the device control model read from the device-control-model database 23 or the device-control-model-sharing database 40, until the state is turned into a goal state of an instruction given by the goal-based-command registration/execution section 26. The goal-based-device controller 25 generates, on the basis of the state transition model 23D, a command list that is necessary for turning into the goal state indicated by the goal-based-command registration/execution section 26, for example. The goal-based-device controller 25 generates, on the basis of the state transition model 23D, the command list that is necessary for turning into the goal state indicated by the goal-based-command registration/execution section 26 from the state of the one or plurality of external devices to be controlled, which is obtained from external-device-state recognizer 21, for example. Subsequently, the goal-based-device controller 25 sequentially executes the commands in the generated command list, for example. The goal-based-device controller 25 sequentially outputs, for example, the commands in the generated command list to the external device controller 22.

It is to be noted that, in a case where the state transition model 23D is a learning model, the goal-based-device controller 25 may input, for example, the state (present state) of the one or plurality of external devices to be controlled obtained from the external-device-state recognizer 21 and the goal state indicated by the goal-based-command registration/execution section 26 to the state transition model 23D, and may obtain, from the state transition model 23D, one or a plurality of commands (specifically, one or a plurality of commands to be executed next) that is necessary for turning into the inputted goal state. At this time, the goal-based-device controller 25 may output the acquired one or plurality of commands to the external device controller 22 every time the one or plurality of commands is obtained from the state transition model 23D, for example. Further, the goal-based-device controller 25 may transition the state of the one or plurality of external devices to be controlled to the goal state by repeating this operation until the present state matches the goal state, for example.

The command/goal state conversion database 27 stores a table (hereinafter referred to as “table D”) in which the voice command and the goal state are associated with each other. The table D corresponds to a specific example of a “third table” according to the present disclosure. The table D is generated by the goal-based-command registration/execution section 26 on the basis of, for example, the voice command inputted by the user via the command acquisition section 10 and the goal state inputted by the user via an unillustrated input IF (Interface). The table D is stored, for example, in a volatile memory such as a DRAM or in a nonvolatile memory such as an EEPROM or a flash memory.

The goal-based-command registration/execution section 26 grasps the goal state corresponding to the voice command inputted from the command acquisition section 10 (utterance interpretation/execution section 13) on the basis of the table stored in the command/goal state conversion database 27. Subsequently, the goal-based-command registration/execution section 26 outputs the grasped goal state to the goal-based-device controller 25. The command/goal state conversion database 27 generates the table D on the basis of, for example, the voice command inputted by the user via the command acquisition section 10 and the goal state inputted by the user via the unillustrated input IF (Interface), and stores the table D in the command/goal state conversion database 27.

### (Creation of Device Control Model M)

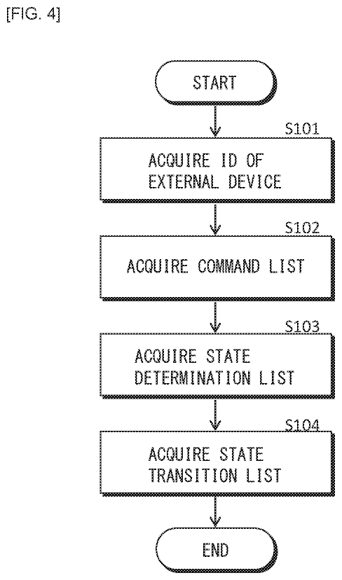

Next, a procedure of creating the device control model M will be described. FIG. 4 illustrates an example of the procedure of creating the device control model M.

First, the device-control-model obtaining section 24 outputs, to the external device controller 22, a signal that allows a certain response to be obtained from the one or plurality of external devices to be controlled. The external device controller 22 generates a predetermined signal on the basis of the signal inputted from the device-control-model obtaining section 24, and outputs the predetermined signal to the one or plurality of external devices to be controlled. Upon receiving the signal from the one or plurality of external devices to be controlled, the external-device-state recognizer 21 outputs the received signal to the device-control-model obtaining section 24. The device-control-model obtaining section 24 generates the external device ID of the one or plurality of external devices to be controlled on the basis of the signal inputted from the external-device-state recognizer 21 (step S101). The device-control-model obtaining section 24 stores the generated external device ID in the device-control-model database 23 and the device-control-model-sharing database 40.

Next, the device-control-model obtaining section 24 acquires the command list 23B from the outside (step S102). The device-control-model obtaining section 24 stores the acquired command list 23B in the device-control-model database 23 and the device-control-model-sharing database 40. Subsequently, the device-control-model obtaining section 24 acquires the state determination list 23C from the outside (step S103). The device-control-model obtaining section 24 stores the acquired state determination list 23C in the device-control-model database 23 and the device-control-model-sharing database 40.

Next, the device-control-model obtaining section 24 outputs each command included in the command list 23B read from the device-control-model database 23 or the device-control-model-sharing database 40 to the external device controller 22. The external device controller 22 outputs the command inputted from the device-control-model obtaining section 24 to the one or plurality of external devices to be controlled. That is, the device-control-model obtaining section 24 outputs the plurality of commands included in the command list 23B read from the device-control-model database 23 or the device-control-model-sharing database 40 to the external device controller 22, thereby causing the plurality of commands to be outputted from the external device controller 22 to the one or plurality of external devices to be controlled. At this time, the external-device-state recognizer 21 recognizes the states of the one or plurality of external devices to be controlled of before and after the transmission of the one or plurality of commands performed by the external device controller 22, and outputs the recognized states of the one or plurality of external devices to the device-control-model obtaining section 24. The device-control-model obtaining section 24 acquires, from the external-device-state recognizer 21, the states of the one or plurality of external devices to be controlled of before and after the transmission of the one or plurality of commands performed by external device controller 22. In addition, the device-control-model obtaining section 24 generates the state transition model 23D on the basis of, for example, the information (external device ID) obtained from the one or plurality of external devices to be controlled, the one or plurality of commands inputted from the device-control-model obtaining section 24 to the external device controller 22 (the one or plurality of commands transmitted from the external device controller 22), and the information (states of the one or plurality of external devices to be controlled of before and after the transmission of the command performed by the external device controller 22) obtained from the external device (step S104).

If the state transition model 23D is a learning model, the device-control-model obtaining section 24 performs, on the state transition model 23D, machine learning using, for example, the goal state specified by the user and the command list 23B read from the device-control-model database 23 or the device-control-model-sharing database 40. Specifically, when a certain goal state is specified by the user, the device-control-model obtaining section 24 first exploratorily outputs the plurality of commands read from the command list 23B to the external device controller 22. The external device controller 22 outputs each command inputted from the device-control-model obtaining section 24 to the one or plurality of external devices to be controlled. At this time, the device-control-model obtaining section 24 acquires, from the external-device-state recognizer 21, the states of the external device corresponding to the external device ID of before and after the transmission of the command performed by the external device controller 22.

The device-control-model obtaining section 24 initially randomly selects the command to be outputted to the external device controller 22 and outputs the randomly selected command to the external device controller 22. Thereafter, the device-control-model obtaining section 24 inputs the state (present state) of the one or plurality of external devices to be controlled obtained from the external-device-state recognizer 21 and the goal state specified by the user into the mid-learning (i.e., incomplete) state transition model 23D, and selects a command outputted from the mid-learning state transition model 23D as the next command to be executed. The device-control-model obtaining section 24 outputs the command outputted from the mid-learning state transition model 23D to the external device controller 22. The device-control-model obtaining section 24 repeats this sequence of operations each time a goal state is specified from the user, eventually generating the state transition model 23D that makes it possible to identify a sequence of commands that may be optimal for causing the state to be transitioned to the goal state when the one or plurality of external devices to be controlled is in any state.

The device-control-model obtaining section 24 stores the generated state transition model 23D in the device-control-model database 23 and the device-control-model-sharing database 40. In this manner, the device control model M is generated.

### (Registration of Voice Command)

Next, registration of the voice command will be described.

First, some issues in registering the voice command will be described. There are various external devices in a home, and contents to be executed may vary depending on the user. For example, achieving a theater mode is assumed. The external device to be controlled may include a television, room lighting, an AV amplifier, and a DVD/BD player. To some extent, it is possible to pre-install a function of the theater mode as a common function. However, input/output settings of each AV device differ depending on a wiring line for each home. Also, one home may have an electrically driven curtain, another home may have indirect lighting in addition to normal lighting, and another home may want to stop an air purifier that generates noise. In view of these circumstances, it is considered important that a relationship between the voice command and the goal state to be achieved is easily customized at the hands of the user.

Further, there is also an issue of how to identify a device to be associated with the voice command. It may be possible to collectively store the states of all the controllable external devices present on the spot as goal states, but it is considered that this is often different from a goal state that the user truly desires. For example, suppose that, as the external devices, there are: a washing robot and a washing machine that are able to perform washing; a cooking robot, a refrigerator, a microwave oven, and a kitchen that are able to perform cooking; a television; an AV amplifier; an electrically driven curtain; and an air conditioner. Assume that the user wants to make it the goal state of the voice command “wash” that the state of the following series of operations, i.e., washing heavy laundry using a washing machine and hanging out the laundry on the balcony, is completed. However, if the state of the cooking robot, the television, or the like is learned together as the goal state, the state of the cooking robot, the television, or the like is reproduced by executing the voice command of “wash” next. Therefore, it is important to appropriately select which external device is to be controlled by the command.

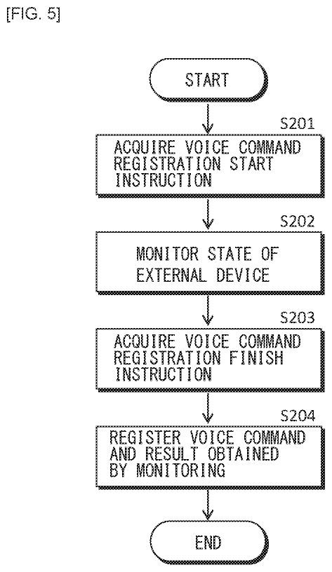

Accordingly, the Applicant has considered that it is appropriate to identify the external device to be controlled in cooperation with the user. FIG. 5 illustrates an example of a procedure of registering a voice command.

First, the goal-based-command registration/execution section 26 acquires a voice command registration start instruction (step S201). More specifically, the user utters a voice command that gives an instruction to start registering the voice command. For example, the user utters “learn the operation to be performed from now”. Then, the command acquisition section 10 acquires the voice command inputted by the user and outputs the acquired voice command to the goal-based-command registration/execution section 26. When the voice command that gives the instruction to start registering the voice command is inputted from the command acquisition section 10, the goal-based-command registration/execution section 26 determines that the voice command registration start instruction has been acquired (step S201).

Upon acquiring the voice command registration start instruction, the goal-based-command registration/execution section 26 starts monitoring the state of the external device (step S202). Specifically, the goal-based-command registration/execution section 26 waits for an input from the external-device-state recognizer 21. Thereafter, the user himself/herself performs operation on the one or plurality of external devices, and at a stage when the operation is finished, the user utters a voice command that gives an instruction to finish registering the voice command. For example, the user may utter “learn this state as xxxxx (command name)”. Then, the command acquisition section 10 acquires the voice command inputted by the user and outputs the acquired voice command to the goal-based-command registration/execution section 26. When the voice command that gives the instruction to finish registering the voice command is inputted from the command acquisition section 10, the goal-based-command registration/execution section 26 determines that a voice command registration finish instruction has been acquired (step S203).

Upon acquiring the voice command registration finish instruction, the goal-based-command registration/execution section 26 identifies one or a plurality of external devices to be operated and identifies a final state of the one or plurality of external devices to be operated as the goal state, on the basis of the input from the external-device-state recognizer 21 obtained during the monitoring. Further, the goal-based-command registration/execution section 26 identifies, as the voice command, a command name (xxxxx) inputted from the command acquisition section 10 during a period from the acquisition of the voice command registration start instruction to the acquisition of the voice command registration finish instruction. The goal-based-command registration/execution section 26 generates the table D in which the identified goal state of the one or plurality of external devices to be operated and the identified voice command are associated with each other, and stores the table D in the command/goal state conversion database 27. In this manner, the goal-based-command registration/execution section 26 registers the voice command and the result obtained by the monitoring to the command/goal state conversion database 27 (step S204).

It is to be noted that the user may, for example, start registering the voice command by pressing a predetermined button provided on the agent device 1. In this case, the goal-based-command registration/execution section 26 may determine that the voice command registration start instruction has been acquired when a signal for detecting that the predetermined button has been pressed by the user has been acquired.

### (Execution of Voice Command)

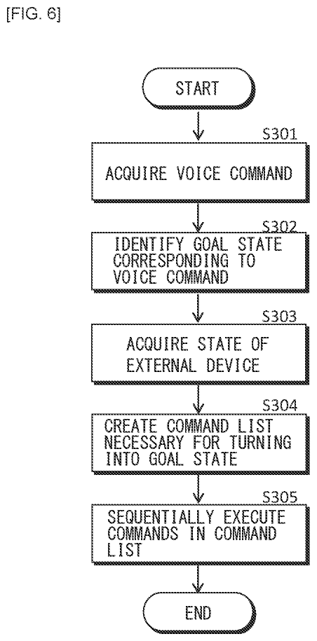

Next, execution of the voice command will be described. FIG. 6 illustrates an example of a procedure of executing the voice command.

First, the goal-based-command registration/execution section 26 acquires the voice command (step S301). Specifically, the user utters a voice command corresponding to the final state of the one or plurality of external devices to be operated. For example, a user may utter “turn into a theater mode”. Then, the command acquisition section 10 acquires the “theater mode” as the voice command inputted by the user, and outputs the “theater mode” to the goal-based-command registration/execution section 26. The goal-based-command registration/execution section 26 acquires the voice command from the command acquisition section 10.

When the voice command is inputted from the command acquisition section 10, the goal-based-command registration/execution section 26 identifies the goal state corresponding to the inputted voice command from the command/goal state conversion database 27 (step S302). Subsequently, the goal-based-command registration/execution section 26 outputs the identified goal state to the goal-based-device controller 25.

When the goal state is inputted from the goal-based-command registration/execution section 26, the goal-based-device controller 25 acquires the present state of the one or plurality of external devices whose goal state is defined from the external-device-state recognizer 21 (step S303). Next, the goal-based-device controller 25 creates, on the basis of the state transition model 23D, the command list that is necessary for turning the state of the one or plurality of external devices to be controlled into the goal state from the present state (step S304). Next, the goal-based-device controller 25 executes sequentially the commands in the generated command list (step S305). Specifically, the goal-based-device controller 25 sequentially outputs the commands in the generated command list to the external device controller 22. As a result, the one or plurality of external devices to be operated becomes the final state corresponding to the voice command

### (Correction of Voice Command)

Next, correction of the voice command will be described.

It is assumed that the correction of the voice command roughly includes at least one of the following: (1) adding new one or a plurality of external devices as the one or plurality of external devices to be operated (further adding the final state of the one or plurality of external devices to be added); (2) deleting one or a plurality of external devices from the one or plurality of external devices to be operated; or (3) changing a final state of at least one external device included in the one or plurality of external devices to be operated. In any of the cases, it is considered appropriate to perform the correction of the voice command on the basis of the registered voice command. The user first gives an instruction to the agent device 1 to execute the registered voice command, and, in the cases of (1) and (3), the user performs an additional operation on an additional external device and gives an instruction to correct the voice command. It is almost similar in the case of (2): after the agent device 1 performs operation on an external device to be deleted, the user gives an instruction to delete the operation.

Similarly, in a case of creating another name of the voice command or a case of creating a new voice command by combining a plurality of voice commands, the user may use the existing commands, manipulate the differences if needed, and register the final state as a new command. This allows the agent device 1 to obtain more complicated operation on the basis of simple operation. In addition, it is based on the goal-based concept, which makes it possible for the agent device 1 to achieve the goal state regardless of the state of each external device at a time of executing the command.

It is also easy to achieve Undo. The agent device 1 may save the state of the external device prior to executing the command, and, upon receiving an instruction to return to the previous state from the user after executing the command, may perform control using the saved state as the goal state.

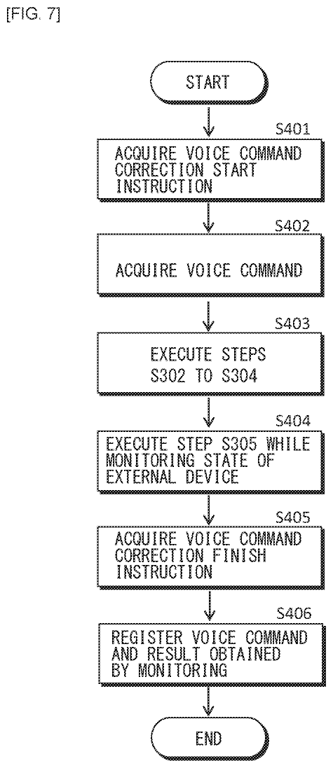

Next, an example of a procedure of correcting the voice command will be described. FIG. 7 illustrates an example of a procedure of correcting the voice command.

First, the goal-based-command registration/execution section 26 acquires a voice command correction start instruction (step S401). Specifically, the user utters a voice command that gives an instruction to start correcting the voice command. For example, the user may utter “correct the voice command” Then, the command acquisition section 10 acquires the voice command inputted by the user and outputs the inputted voice command to the goal-based-command registration/execution section 26. When the voice command that gives the instruction to start correcting the voice command is inputted from the command acquisition section 10, the goal-based-command registration/execution section 26 determines that the voice command correction start instruction has been acquired (step S401).

After acquiring the voice command correction start instruction, the goal-based-command registration/execution section 26 acquires the voice command to be corrected (step S402). Specifically, the user utters the voice command to be corrected. For example, the user may utter “correct theater mode”. Then, the command acquisition section 10 acquires the voice command inputted by the user and outputs the inputted voice command to the goal-based-command registration/execution section 26. The goal-based-command registration/execution section 26 acquires the voice command to be corrected from the command acquisition section 10 (step S402).

When the goal-based-command registration/execution section 26 acquires the voice command correction start instruction and the voice command to be corrected from the command acquisition section 10, the goal-based-command registration/execution section 26 executes steps S302 to S304 described above (step S403). Subsequently, the goal-based-command registration/execution section 26 executes step S305 described above while monitoring the state of the one or plurality of external devices to be operated (step S404). That is, the goal-based-command registration/execution section 26 executes the one or plurality of commands that is necessary for turning into the goal state corresponding to the voice command to be corrected, while monitoring the state of the one or plurality of external devices to be operated. At this time, the user operates the one or plurality of external devices to be newly added as an operation target, gives an instruction to delete an operation performed by the agent device 1, and changes the final state of at least one external device included in the operation target, for example. The goal-based-command registration/execution section 26 identifies the goal state corresponding to the voice command to be corrected by performing the process corresponding to the instruction as described above from the user. It is to be noted that the goal-based-command registration/execution section 26 may omit monitoring of the state of the one or plurality of external devices to be operated or executing the one or plurality of commands that is necessary for turning into the goal state corresponding to the voice command to be corrected, when performing the process corresponding to the instruction as described above from the user.

Thereafter, the user utters a voice command that gives an instruction to finish correcting the voice command. For example, the user may utter “learn this state as xxxxx (command name)”. Then, the command acquisition section 10 acquires the voice command inputted by the user and outputs the acquired voice command to the goal-based-command registration/execution section 26. When the voice command that gives the instruction to finish correcting the voice command is inputted from the command acquisition section 10, the goal-based-command registration/execution section 26 determines that a voice command correction finish instruction has been acquired (step S405).

Upon acquiring the voice command correction finish instruction, the goal-based-command registration/execution section 26 identifies one or plurality of external devices to be operated and identifies a final state of the one or plurality of external devices to be operated as the goal state, on the basis of the input from the external-device-state recognizer 21 obtained during the monitoring. Further, the goal-based-command registration/execution section 26 identifies, as the voice command, a command name (xxxxx) inputted from the command acquisition section 10. The goal-based-command registration/execution section 26 generates the table D in which the identified goal state of the one or plurality of external devices to be operated and the identified voice command are associated with each other, and stores the table D in the command/goal state conversion database 27. In this manner, the goal-based-command registration/execution section 26 registers the voice command and the result obtained by the monitoring to the command/goal state conversion database 27 (step S406). As a result, the correction of the voice command is completed.

It is to be noted that the user may, for example, start correcting the voice command by pressing a predetermined button provided on the agent device 1. In this case, the goal-based-command registration/execution section 26 may determine that the voice command correction start instruction has been acquired when a signal for detecting that the predetermined button has been pressed by the user has been acquired.

### [Effects]

Next, effects of the agent device 1 will be described.

When an application is started by voice recognition, it is desired to reduce burden on the user for the utterance by starting the application with the shortest utterance. For example, it is desired to be able to play music by simply saying “music” instead of saying “play music”. However, in a case of attempting to start the application with the shortest utterance, there has been an issue that a probability of malfunction is increased due to a surrounding speaking voice or noise.

In contrast, the agent device 1 according to the present embodiment generates the state transition model 23D in which the plurality of commands transmitted to the one or plurality of external devices to be controlled and the states of the one or plurality of external devices of before and after the transmission of the plurality of commands are associated with each other. Thus, it is possible to control the one or plurality of external devices to be controlled toward the goal state corresponding to the command inputted from the outside, while selecting the command to be executed from the state transition model 23D. Accordingly, it is possible to operate a surrounding device to be brought into the goal state by inputting one voice command, and to operate the agent device 1 intuitively. Further, it also allows the user to add and correct his/her own voice command without necessitating any specific skills.

Further, in the present embodiment, the command list 23B and the state determination list 23C are provided in the device-control-model database 23. Thus, use of the command list 23B, the state determination list 23C, and the state transition model 23D makes it possible to operate the surrounding device to be brought into the goal state by inputting one voice command.

Further, in the present embodiment, the command acquisition section 10, the command/goal state conversion database 27, and the goal-based-command registration/execution section 26 are provided. Thus, it is possible to control the one or plurality of external devices to be controlled toward the goal state corresponding to the command inputted from the outside, while selecting the command to be executed from the state transition model 23D. Accordingly, it is possible to operate the surrounding device to be brought into the goal state by inputting one voice command.

In the present embodiment, the state transition model 23D is provided in the device-control-model database 23. Thus, use of the command list 23B, the state determination list 23C, and the state transition model 23D provided in the agent device 1 makes it possible to operate the surrounding device to be brought into the goal state by inputting one voice command.

Further, in the present embodiment, the state transition model 23D is provided in the device-control-model-sharing database 40 on the network. This eliminates the necessity to perform machine learning for each agent device, because the device-control-model-sharing database 40 on the network is usable by other agent devices, and reduces the time and effort necessary to create the model.

Further, in the present embodiment, in the case where a portion of the state transition model 23D is created by using programming or the like, without using machine learning (e.g., reinforcement learning), it is possible to provide a control model which is difficult to achieve by machine learning or a more efficient control model.

### 3. MODIFICATION EXAMPLES

Next, modification examples of the agent device 1 according to the above-described embodiment will be described.

### Modification Example A

In the above-described embodiment, the voice agent cloud service 30 may be omitted. In this case, the utterance interpretation/execution section 13 may be configured to convert the received utterance voice data into text by voice recognition. Further, in the above-described embodiment, the voice recognizer 12, the utterance interpretation/execution section 13, and the voice synthesizer 14 may be omitted. In this case, a cloud service providing functions of the voice recognizer 12, the utterance interpretation/execution section 13, and the voice synthesizer 14 may be provided on the network, and the command acquisition section 10 may transmit the sound signal obtained by the microphone 11 to the cloud service via the network and receive the sound signal generated by the cloud service via the network.

### Modification Example B

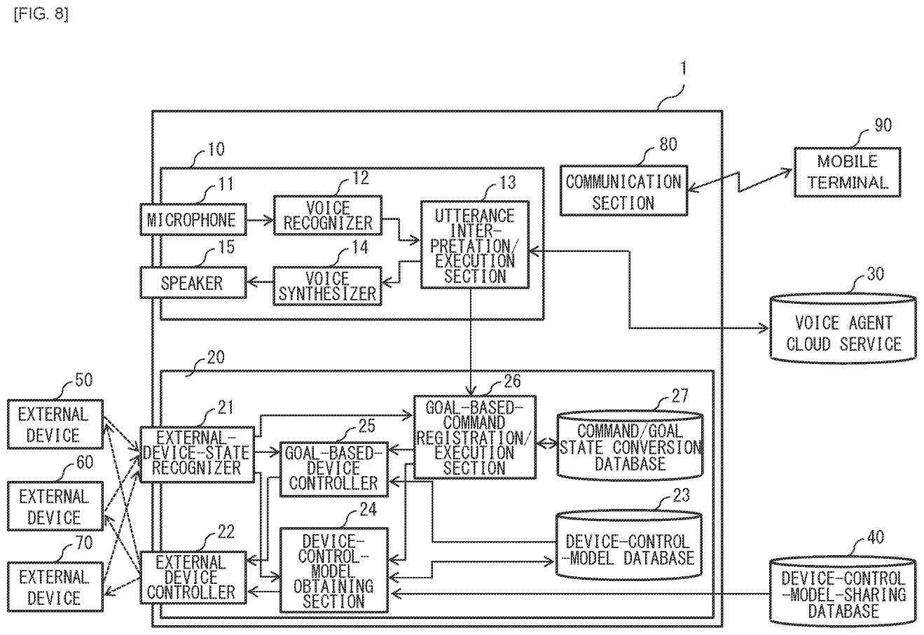

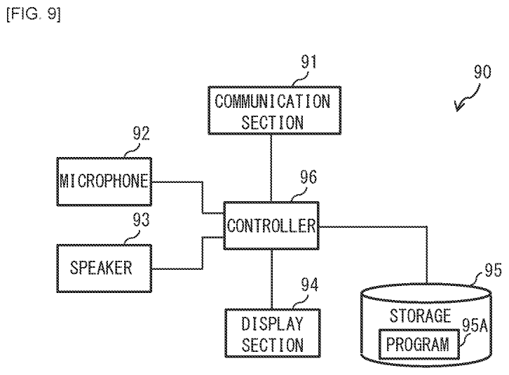

In the embodiment and the modification example described above, the agent device 1 may include a communication section 80 that is communicable with a mobile terminal 90, as illustrated in FIG. 8, for example. The mobile terminal 90 provides an UI (User Interface) of the agent device 1. For example, as illustrated in FIG. 9, the mobile terminal 90 includes a communication section 91, a microphone 92, a speaker 93, a display section 94, a storage 95, and a controller 96.

The communication section 91 is configured to be communicable with the mobile terminal 90 via a network. The network is, for example, a network that performs communication using a communication protocol (TCP/IP) that is normally used on the Internet. The network may be, for example, a secure network that performs communication using a communication protocol of its own network. The network may be, for example, the Internet, an intranet, or a local area network. The network and the agent device 1 may be coupled to each other via, for example, a wired LAN such as Ethernet (registered trademark), a wireless LAN such as a Wi-Fi, a cellular telephone line, or the like.

The microphone 92 receives ambient sound and outputs a sound signal obtained therefrom to the controller 96. The speaker 93 converts the inputted sound signal into a voice, and outputs the voice to the outside. The display section 94 is, for example, a liquid crystal panel, or an organic EL (Electro Luminescence) panel. The display section 94 displays an image on the basis of an image signal inputted from the controller 96. The storage 95 may be, for example, a volatile memory such as a DRAM, or a non-volatile memory such as an EEPROM or flash memory. The storage 95 includes a program 95A for providing the UI of the agent device 1. Loading the program 95A into the controller 96 causes the controller 96 to execute operation written in the program 95A.

The controller 96 generates an image signal including information inputted from the agent device 1 via the communication section 91, and outputs the image signal to the display section 94. The controller 96 outputs the sound signal obtained by the microphone 92 to the agent device 1 (voice recognizer 12) via the communication section 91. The voice recognizer 12 extracts an utterance voice signal of the user, which is included in the sound signal inputted from the mobile terminal 90, and outputs the utterance voice signal to the utterance interpretation/execution section 13.

In the present modification example, the mobile terminal 90 provides the UI of the agent device 1. This makes it possible to reliably input the voice command into the agent device 1 even if the agent device 1 is far from the user.

### Modification Example C

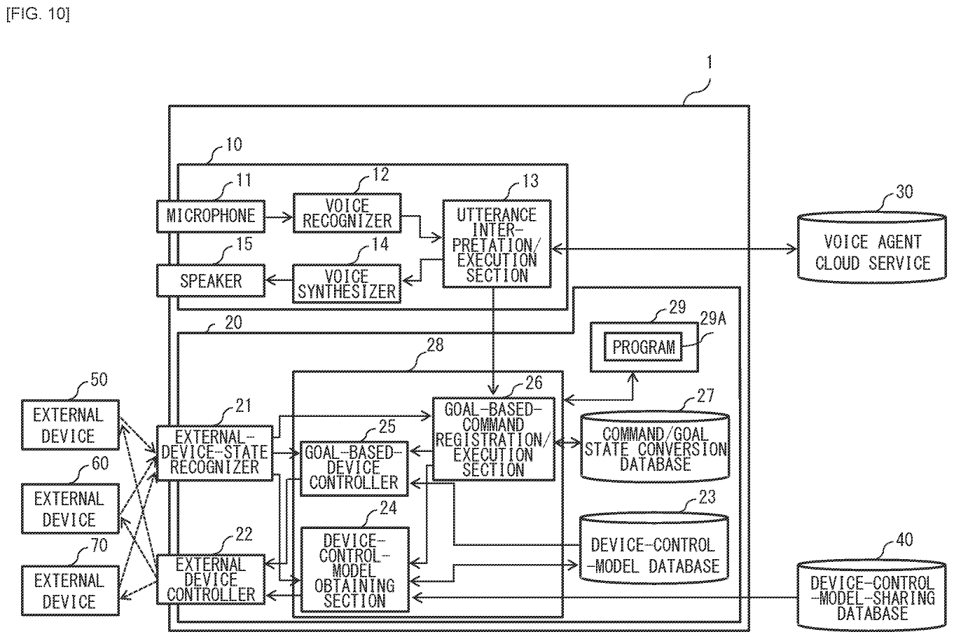

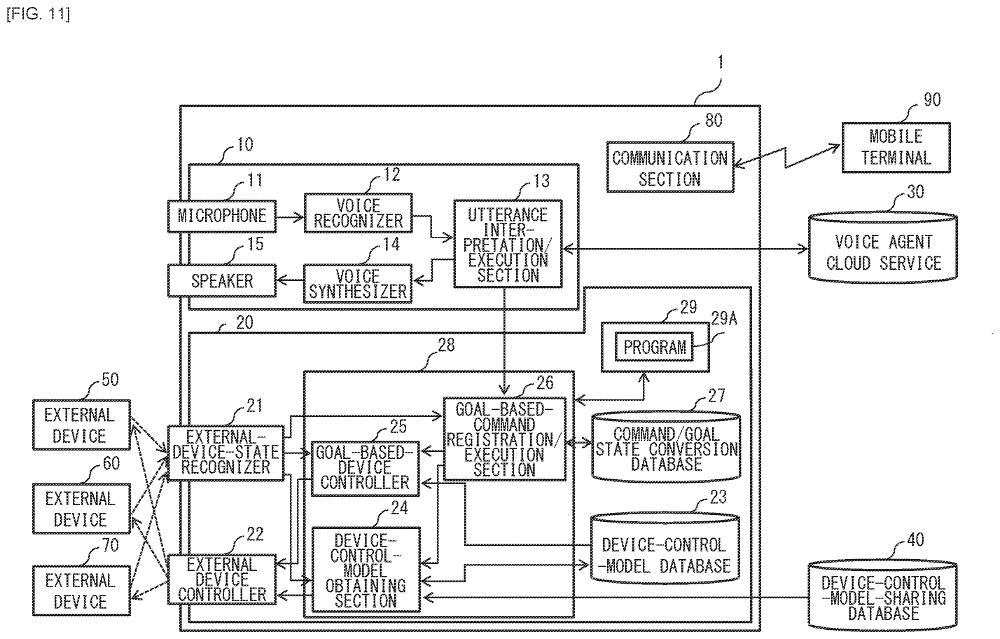

In the embodiment and the modification examples described above, a series of processes to be executed by the device-control-model obtaining section 24, the goal-based-device controller 25, and the goal-based-command registration/execution section 26 may be implemented by a program. For example, as illustrated in FIGS. 10 and 11, the goal-based execution section 20 may include a calculation section 28 and a storage 29. The storage 29 may be, for example, a volatile memory such as a DRAM, or a non-volatile memory such as an EEPROM or a flash memory. The storage 29 includes a program 29A for executing a series of processes to be executed by the device-control-model obtaining section 24, the goal-based-device controller 25, and the goal-based-command registration/execution section 26. Loading the program 29A into the calculation section 28 causes the calculation section 28 to execute operation written in the program 29A.

Further, for example, the present disclosure may have the following configurations.

(1)

An information processing device including:

an external device controller that transmits a plurality of commands to one or a plurality of external devices to be controlled;

an external-device-state recognizer that recognizes states of the one or plurality of external devices of before and after transmission of the plurality of commands performed by the external device controller; and

a model obtaining section that generates a state transition model in which the plurality of commands transmitted from the external device controller is associated with the states of the one or plurality of external devices of before and after the transmission of the plurality of commands performed by the external device controller.

(2)

The information processing device according to (1), further including a storage that stores

a first table in which a plurality of identifiers respectively assigned to the external devices on a one-by-one basis is associated with a plurality of commands that is acceptable in each of the external devices,

a second table in which the plurality of identifiers is associated with information regarding a method configured to determine a state of each of the external devices, and

the state transition model.

(3)

The information processing device according to (1) or (1), further including:

a command acquisition section that acquires a voice command by voice recognition;

a third table in which the voice command is associated with a goal state; and

an execution section that grasps, from the third table, the goal state corresponding to the voice command acquired by the command acquisition section, generates one or a plurality of commands that is necessary for turning into the grasped goal state, and executes the generated one or plurality of commands.

(4)

The information processing device according to any one of (1) to (3), further including a storage that stores the state transition model generated by the model obtaining section.

(5)

The information processing device according to any one of (1) to (3), in which the model obtaining section stores the generated state transition model in a storage on a network.

(6)

The information processing device according to any one of (1) to (5), in which the external-device-state recognizer includes at least one of a communication device configured to communicate with the one or plurality of external devices, an imaging device configured to image the one or plurality of external devices, a sound collecting device configured to acquire a sound outputted by the one or plurality of external devices, or a reception device configured to receive an infrared remote control code transmitted to the one or plurality of external devices.

(7)

The information processing device according to (3), in which the state transition model is a learning model generated by machine learning, and is configured to, when a state of the one or plurality of external devices and the goal state are inputted, output one or a plurality of commands necessary for turning into the inputted goal state.

(8)

The information processing device according to (2), further including an identifier generator that generates, on a basis of information obtained from the one or plurality of external devices, the identifier for each of the external devices.

(9)

The information processing device according to (3), in which, upon acquiring a voice command registration start instruction, the execution section starts monitoring a state of the one or plurality of external devices, and, upon acquiring a voice command registration finish instruction, the execution section identifies one or a plurality of external devices to be operated and identifies a final state of the one or plurality of external devices to be operated as a goal state, on a basis of input from the external-device-state recognizer obtained during the monitoring.

(10)

The information processing device according to (9), in which the execution section creates the third table by associating a voice command inputted by a user with the goal state.

(11)

The information processing device according to (9) or (10), in which the execution section creates the third table by associating, with the goal state, a voice command inputted by a user during a period from acquisition of the voice command registration start instruction to acquisition of the voice command registration finish instruction.

(12)

The information processing device according to (9), in which, upon acquiring a voice command correction start instruction and a voice command to be corrected, the execution section identifies a goal state corresponding to the voice command to be corrected by performing a process corresponding to an instruction from a user.

(13)

The information processing device according to (12), in which, upon acquiring a voice command correction start instruction and a voice command to be corrected, the execution section identifies a goal state corresponding to the voice command to be corrected by executing one or a plurality of commands that is necessary for turning into the goal state corresponding to the voice command to be corrected while monitoring the state of the one or plurality of external devices, and by performing a process corresponding to an instruction from a user.

(14)

The information processing device according to (12), in which the execution section performs, as a process corresponding to the instruction from the user, at least one of adding new one or a plurality of external devices to the one or plurality of external devices to be operated, deleting one or a plurality of external devices from the one or plurality of external devices to be operated, or changing a final state of at least one external device included in the one or plurality of external devices to be operated.

(15)

An information processing method including:

transmitting a plurality of commands to one or a plurality of external devices to be controlled, and recognizing states of the one or plurality of external devices of before and after transmission of the plurality of commands by receiving responses of the plurality of commands; and

generating a state transition model in which the transmitted plurality of commands is associated with the states of the one or plurality of external devices of before and after the transmission of the plurality of commands.

(16)

An information processing program that causes a computer to execute,

by outputting a plurality of commands to an external device controller, causing the plurality of commands to be outputted, from the external device controller, to one or a plurality of external devices to be controlled, and thereafter obtaining states of the one or plurality of external devices of before and after transmission of the plurality of commands by receiving responses of the plurality of commands, and

generating a state transition model in which the outputted plurality of commands is associated with the states of the one or plurality of external devices of before and after the transmission of the plurality of commands.

In the information processing device, the information processing method, and the information processing program according to an embodiment of the present disclosure, the state transition model is generated in which the plurality of commands transmitted to the one or plurality of external devices to be controlled and the states of the one or plurality of external devices of before and after the transmission of the plurality of commands are associated with each other. Thus, it is possible to control the one or plurality of external devices to be controlled toward the goal state corresponding to the command inputted from the outside, while selecting the command to be executed from the state transition model. Accordingly, it is possible to operate the surrounding device to be brought into the goal state by inputting one voice command.

This application claims the benefit of Japanese Priority Patent Application JP2019-100956 filed with the Japan Patent Office on May 30, 2019, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An information processing device comprising:
an external device controller that transmits a plurality of commands to one or a plurality of external devices to be controlled;
an external-device-state recognizer that recognizes states of the one or plurality of external devices of before and after transmission of the plurality of commands performed by the external device controller; and
a model obtaining section that generates a state transition model in which the plurality of commands transmitted from the external device controller is associated with the states of the one or plurality of external devices of before and after the transmission of the plurality of commands performed by the external device controller.

2. The information processing device according to claim 1, further comprising a storage that stores
a first table in which a plurality of identifiers respectively assigned to the external devices on a one-by-one basis is associated with a plurality of commands that is acceptable in each of the external devices, and
a second table in which the plurality of identifiers is associated with information regarding a method configured to determine a state of each of the external devices.

3. The information processing device according to claim 1, further comprising:
a command acquisition section that acquires a voice command by voice recognition;
a third table in which the voice command is associated with a goal state; and
an execution section that grasps, from the third table, the goal state corresponding to the voice command acquired by the command acquisition section, generates one or a plurality of commands that is necessary for turning into the grasped goal state, and executes the generated one or plurality of commands.

4. The information processing device according to claim 1, further comprising a storage that stores the state transition model generated by the model obtaining section.

5. The information processing device according to claim 1, wherein the model obtaining section stores the generated state transition model in a storage on a network.

6. The information processing device according to claim 1, wherein the external-device-state recognizer includes at least one of a communication device configured to communicate with the one or plurality of external devices, an imaging device configured to image the one or plurality of external devices, a sound collecting device configured to acquire a sound outputted by the one or plurality of external devices, or a reception device configured to receive an infrared remote control code transmitted to the one or plurality of external devices.

7. The information processing device according to claim 3, wherein the state transition model is a learning model generated by machine learning, and is configured to, when a state of the one or plurality of external devices and the goal state are inputted, output one or a plurality of commands necessary for turning into the inputted goal state.

8. The information processing device according to claim 2, further comprising an identifier generator that generates, on a basis of information obtained from the one or plurality of external devices, the identifier for each of the external devices.

9. The information processing device according to claim 3, wherein, upon acquiring a voice command registration start instruction, the execution section starts monitoring a state of the one or plurality of external devices, and, upon acquiring a voice command registration finish instruction, the execution section identifies one or a plurality of external devices to be operated and identifies a final state of the one or plurality of external devices to be operated as a goal state, on a basis of input from the external-device-state recognizer obtained during the monitoring.

10. The information processing device according to claim 9, wherein the execution section creates the third table by associating a voice command inputted by a user with the goal state.

11. The information processing device according to claim 9, wherein the execution section creates the third table by associating, with the goal state, a voice command inputted by a user during a period from acquisition of the voice command registration start instruction to acquisition of the voice command registration finish instruction.

12. The information processing device according to claim 9, wherein, upon acquiring a voice command correction start instruction and a voice command to be corrected, the execution section identifies a goal state corresponding to the voice command to be corrected by performing a process corresponding to an instruction from a user.

13. The information processing device according to claim 12, wherein, upon acquiring a voice command correction start instruction and a voice command to be corrected, the execution section identifies a goal state corresponding to the voice command to be corrected by executing one or a plurality of commands that is necessary for turning into the goal state corresponding to the voice command to be corrected while monitoring the state of the one or plurality of external devices, and by performing a process corresponding to an instruction from a user.

14. The information processing device according to claim 12, wherein the execution section performs, as a process corresponding to the instruction from the user, at least one of adding new one or a plurality of external devices to the one or plurality of external devices to be operated, deleting one or a plurality of external devices from the one or plurality of external devices to be operated, or changing a final state of at least one external device included in the one or plurality of external devices to be operated.

15. An information processing method comprising:
transmitting a plurality of commands to one or a plurality of external devices to be controlled, and recognizing states of the one or plurality of external devices of before and after transmission of the plurality of commands by receiving responses of the plurality of commands; and
generating a state transition model in which the transmitted plurality of commands is associated with the states of the one or plurality of external devices of before and after the transmission of the plurality of commands.

16. An information processing program that causes a computer to execute,
by outputting a plurality of commands to an external device controller, causing the plurality of commands to be outputted, from the external device controller, to one or a plurality of external devices to be controlled, and thereafter obtaining states of the one or plurality of external devices of before and after transmission of the plurality of commands by receiving responses of the plurality of commands, and
generating a state transition model in which the outputted plurality of commands is associated with the states of the one or plurality of external devices of before and after the transmission of the plurality of commands.
